(19) United States
(12) Patent Application Publication
(10) Pub. No.: US 2026/0263305 A1
(43) Pub. Date: Sep. 10, 2026

(54) ORTHOPEDIC PATIENT POSITIONER APPARATUS, SYSTEM, AND METHOD FOR HIP ARTHROPLASTY

(71) Applicant: INNOVATIVE MEDICAL PRODUCTS, INC., PLAINVILLE, CT (US)

(72) Inventor: Tamas KOVACS, Burlington, CT (US)

(73) Assignee: INNOVATIVE MEDICAL PRODUCTS, INC., PLAINVILLE, CT (US)

(21) Appl. No.: 19/249,373

(22) Filed: Jun. 25, 2025

Related U.S. Application Data
(63) Continuation-in-part of application No. 30/002,164, filed on May 2, 2025.
(63) Continuation-in-part of application No. 19/075,740, filed on Mar. 10, 2025.

(51) Int. Cl. A61G 13/12

(52) U.S. Cl. CPC A61G 13/123; A61G 13/129; A61G 13/1295

(57) ABSTRACT

A surgical patient positioner is described wherein a base plate includes a plurality of tracks configured to slidably couple to anterior and posterior support assemblies, useful for lateral decubitus surgical procedures, such as hip arthroplasty. The base plate is contoured to fit between the pelvis and rib cage of the patient to avoid pressuring skeletal tissue, and includes ratchet recesses coupled with quick release latches. An anterior base may be configured relative to an anterior tower in multiple angles to support the patient in a manner that facilitates flexion of the limb, to test, for example, flexion and/or movement of the patient's joint while still fixedly coupled during surgery. The arrangement also provides for more precision with respect to anchoring of the patient to the OR table. A lock pin ramp portion provides for single-handed assembly of the anterior tower to the anterior base, for ease of assembly.

### CROSS-REFERENCE TO RELATED APPLICATION

This application is a continuation-in-part, and claims priority to, and the benefit of: co-pending U.S. Design Patent Application No. 30/002,164 filed on May 2, 2025 and entitled “Orthopedic Positioner Support Base With Multiple Slots”; and co-pending U.S. patent application Ser. No. 19/075,740 filed on Mar. 10, 2025 and entitled “Orthopedic Patient Positioner Apparatus, System, And Method For Hip Arthroplasty”, each of which is incorporated herein by reference in its entirety.

### TECHNICAL FIELD

The present invention relates generally to an orthopedic positioner apparatus, system, and method and, in particular, to a radiolucent positioner system for supporting the pelvic skeleton of a patient for a surgical procedure using robotics and imaging during the procedure.

### BACKGROUND

Conventional positioner systems generally provide support for a patient when undergoing a predetermined surgical procedure such as, for example, total hip arthroplasty—more commonly known as a hip replacement surgery. Prosthetic hip joints are routinely used to replace a patient's hip joint when that joint is damaged. Currently many tens of thousands of such hip replacement operations are performed each year around the world, and that number is increasing. For total hip arthroplasty (or possibly for repairing a hip fracture), positioner systems may support a patient in a position lying on one side, commonly referred to as a lateral decubitus position.

Conventional lateral decubitus positioner systems are subject to a variety of disadvantages. First, positioners can slip during surgery thereby repositioning the body of the patient, which has adverse effects to the surgical procedure and health of the patient. Threaded fasteners are typically used to hold component parts of the system, and these fasteners cause radio-opaque interference and are subject to undesired loosening or slipping on account of the physical forces applied to the patient during surgery. Modern hip replacement surgeries may also use imaging and robotic equipment that require firm immobilization of the patient. In this respect, robotic surgery typically relies on a frame of reference, such as a coordinate system, that needs to be maintained throughout the procedure—so that the robot knows where it is in three-dimensional space—and changing the location of the body relative to that coordinate system is generally not desirable. Radio-opaque interference introduced by the positioner in the frame of reference is also undesirable.

Conventional hip positioners typically comprise complex structural assemblies that may obstruct the surgical area, such as, for example, bars, plates and extensions that restrict access to the surgical area. Obstruction of the surgical site is undesirable for at least several reasons. For one, positioners get in the way of the surgeon or robot. For another, the positioner typically blocks radiography and imaging techniques when the patient is positioned for surgery, such as a lateral decubitus position. Many component parts of conventional positioner systems employ, for example, radio-opaque metals and metal alloys. For yet another, the positioner may inhibit range of motion checks where, for example, it may be desirable to flex the hip beyond 90 degrees to check the range of motion and stability of the hip joint, among other reasons.

A further requirement of positioners is that they should accommodate patients of varying size and shape. For example, an obese patient will have different holding characteristics than a non-obese patient. Similarly, a patient with a large pannus—which refers to an overgrowth of tissue, often associated with conditions like rheumatoid arthritis (affecting joints) or in cases of morbid obesity, where it describes excess abdominal skin and fat that hangs over the lower abdomen—will require a patient positioner with the flexibility to accommodate the patient's shape, while achieving the desired stability and holding.

Conventional hip positioner support assemblies may also have numerous parts that are difficult to clean; even though total hip arthroplasty uses positioners that are typically non-sterile, the parts must still be sterilized between surgeries, as well as assembled, disassembled, and stored. Additionally, conventional positioners may cause damage to the patient's tissues by virtue of the holding forces imparted to the body and/or restriction of the circulatory system, and/or other complications attributable to the pressure applied to the body. In one example, the support plate (which comes in contact with the support table and the lower side of a patient in a lateral decubitus position), can cause damage or post-surgical discomfort. Even though the support plate may be covered with padding, over the course of the surgery this may cause significant patient discomfort.

It is therefore desirable, and indeed a long-felt need in the industry exists, to provide an improved apparatus, system, and method of patient positioning that eliminates the aforementioned and other drawbacks to produce better surgical outcomes.

### SUMMARY

It is an object of the apparatus, system, and method according to the present invention to provide a surgical patient positioner capable of improved holding characteristics, including multiple, discrete adjustments, such as pawl and ratcheting mechanisms, and the like. This disclosure contemplates providing multiple discrete adjustments that reduce or eliminate the likelihood of unintended movement once the patient is put in the desired position. Accordingly, the positioning of the patient is improved.

It is another object of the apparatus, system, and method according to the present invention to provide a surgical patient positioner comprising an anterior tower including a lock pin assembly generally purposed to prevent slippage and achieve safe and secured locking between the anterior tower and anterior base, while simultaneously providing for quick and effective assembly and/or disassembly of the positioner. An anterior base may be configured relative to an anterior tower in multiple angles to support the patient in a manner that facilitates, for example flexion of the limb during surgery. This arrangement provides for other desirable characteristics such as flexion of the patient's limb while still fixedly coupled during surgery, such as testing movement of the joint. Similarly, the arrangement provides for more precision with respect to anchoring of the patient to the OR table and is configured for proper assembly. A lock pin ramp portion may be utilized, which provides for single-handed placement and/or assembly of the anterior tower with respect to the anterior base, for ease of assembly.

It is another object of the apparatus, system, and method according to the present invention to provide a surgical patient positioner that minimizes obstruction of the surgical area by reduction of parts. Accordingly, the invention provides surgical personnel with improved room to operate, as well as for imaging access and other purposes, such as use of a fluoroscopy C-Arm while the patient is in position. In one aspect, embodiments of the present invention provide a support plate adapted for extended flexion of the hip and other range of motion checks conducted during the surgery.

It is another object of the apparatus, system, and method according to the present invention to provide a surgical patient positioner that is easily and intuitively adjustable, with improved versatility to accommodate patients of varying sizes and positioning requirements. For example, this disclosure contemplates embodiments of the present invention that are well suited to accommodate patients with a large pannus, without compromising the positioning stability of the device.

It is another object of the apparatus, system, and method according to the present invention to provide a surgical patient positioner that reduces damage to the patient's tissues and reduces post-surgical discomfort.

In one aspect, it is contemplated that the surgical patient positioner may operate effectively as a three-point positioning system: (i) lower back at the rear of the pelvis, (ii) upper iliac crest, and (iii) lower iliac crest. Other rigid mechanical positioning is considered to fall within the scope of this disclosure, such as coupling to other body parts than those discussed above.

In another aspect, conventional latching, or holding, mechanisms may loosen over time and/or may not otherwise provide for secure holding. The surgical patient positioner 100 according to the present invention overcomes these disadvantages.

In another aspect, the surgical patient positioner 100 reduces the number of parts, thereby achieving a superior technical advantage over conventional designs.

In another aspect, the surgical patient positioner 100 reduces the number and severity of reentrant surfaces which makes the positioner 100 easier to clean and sterilize in between surgeries, in accordance with medical cleanliness standards.

In another aspect, the surgical patient positioner 100 is easier to set up because it requires no threaded parts. Similarly, the quick release nature of the rachet and latch systems make takedown quicker than conventional designs.

In another aspect, both the anterior and posterior support systems are locked to the OR table.

In another aspect, solid locking mechanisms are used, instead of knobs, where the latter tend to loosen and the former do not.

In another aspect, all, or substantially all, of the components of the surgical patient positioner are made of plastic such as Delfin, which provides for a lighter system, that gives more space for the doctor to work in, is easier to set up, and is translucent, so that radiography and other imaging can be done in situ. Other materials may be substituted that achieve one or more of the desired objectives stated herein.

Other desirable features and characteristics will become apparent from the subsequent detailed description, the drawings, and the appended claims, when considered in view of this background.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1 illustrates a front, top, left-side perspective view of a surgical patient positioner, according to an embodiment of the present invention;

FIG. 2 illustrates a back, top, left-side perspective view of a surgical patient positioner, according to an embodiment of the present invention;

FIG. 3 illustrates an exploded, front, top, left-side perspective view of a surgical patient positioner, according to an embodiment of the present invention;

FIG. 4 illustrates a front, top, left-side perspective view of an anterior tower assembly of a surgical patient positioner, according to an embodiment of the present invention;

FIG. 5A illustrates a front, top, left-side perspective view of a multi-slot anterior base for a surgical patient positioner, according to an embodiment of the present invention;

FIG. 5B illustrates a top view of the multi-slot anterior base for a surgical patient positioner, according to the embodiment of the present invention;

FIG. 5C illustrates a bottom view of the multi-slot anterior base for a surgical patient positioner, according to the embodiment of the present invention;

FIG. 6A illustrates an enlarged sectional view of the anterior support assembly taken along section line X′-X′ of FIG. 4 with the locking pin assembly in the locked position, according to an embodiment of the present invention;

FIG. 6B illustrates an enlarged sectional view of the anterior support assembly taken along section line X′-X′ of FIG. 4 with the locking pin assembly in the release position, according to an embodiment of the present invention; and

FIG. 7 is an environmental view of a patient secured to an OR table by a surgical patient positioner, according to an embodiment of the present invention.

### DETAILED DESCRIPTION

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention. For a better understanding of the present invention, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

For ease of reference, “anterior” as used herein refers to the side of a support table closest to the front side of the patient, i.e., the front of the patient faces that lateral side of the table. The term “posterior,” as used herein, refers to the opposite side as that of the “anterior”.

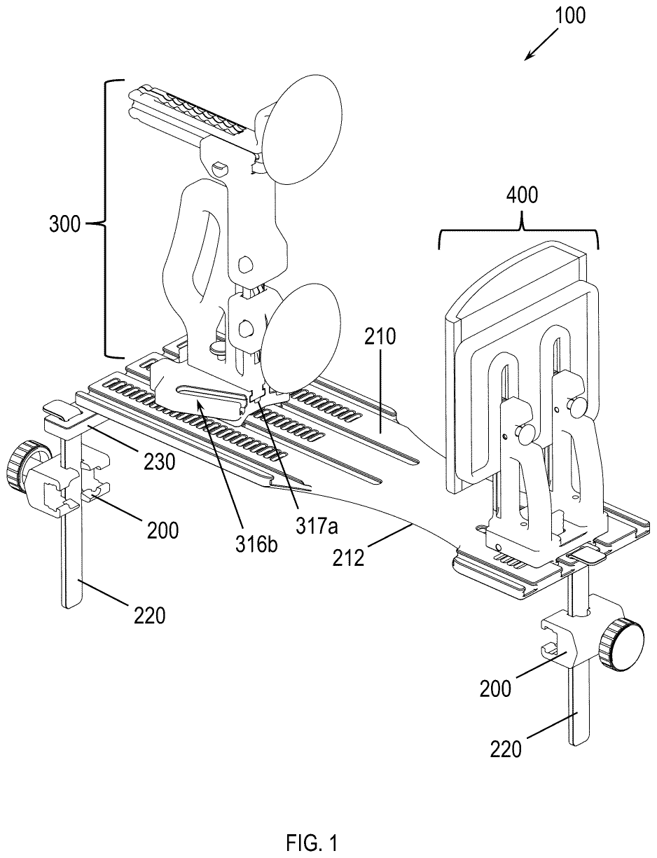

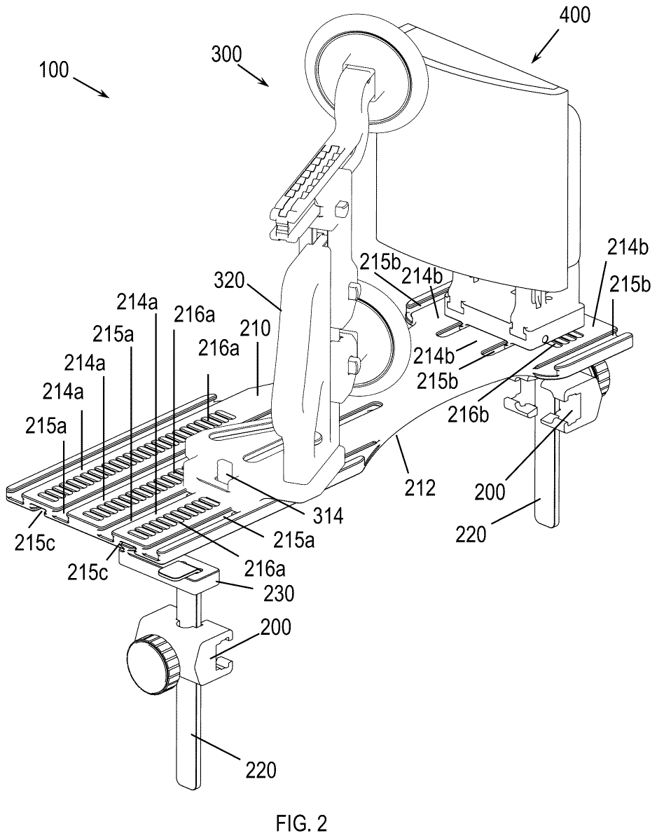

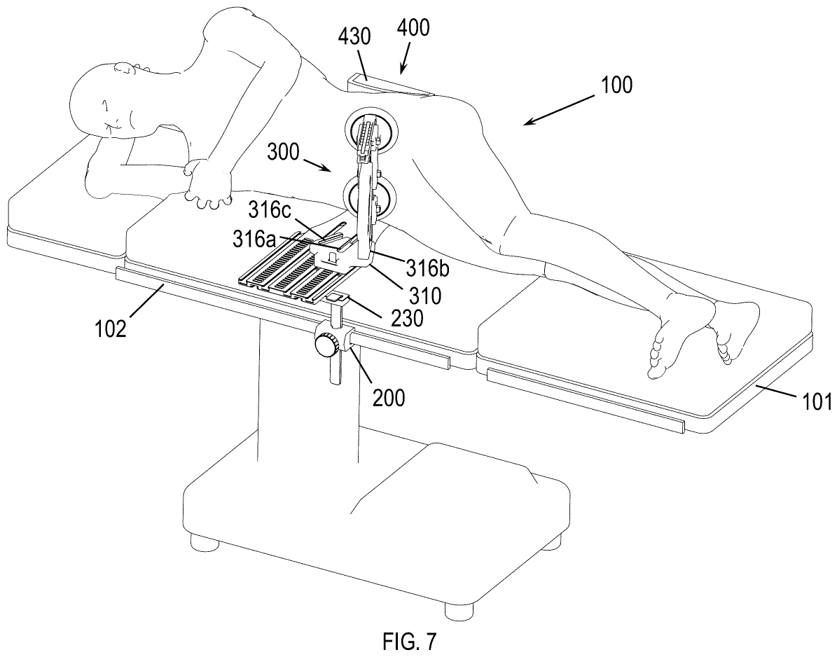

Referring to FIGS. 1-7, an apparatus, system, and method for securing or otherwise positioning a patient to a support table, such as an operating room (OR) table 101, is generally referred to as element 100; the surgical patient positioner 100 is described in one or more exemplary embodiments of the present invention. The surgical patient positioner 100 may be usefully employed in a variety of applications and fields of medicine. For example, as shown in FIG. 7, the positioner 100 may be used to hold a surgical patient in the lateral decubitus position for total hip arthroplasty. Other applications of the positioner 100 include, but are not limited to, surgery to repair a hip fracture. The positioner 100 is advantageously suitable for radiography applications where radio-translucence may be useful so that imaging is not obstructed. FIGS. 1 and 2 show the assembled surgical patient positioner 100 from different perspectives. The surgical patient positioner 100 may comprise a base plate 210 which may be coupled to either or both side rails 102 of a support table, such as an OR table 101. In a preferred embodiment, one or more clamps 200 may couple to each side rail 102, the clamp 200 configured to receive a drop bar 220. Clamp 200 can be a rail clamp designed to accept OR table accessories that have a flat or round insertion end, such as, for example, a drop bar manufactured and offered for sale by Innovative Medical Products, Inc., CAT #409. Advantageously, an extension bracket 230 may couple the drop bar 220 to the base plate 210, or conversely, the drop bar 220 may couple directly to the base plate 210. The patient may be positioned on the base plate 210, preferably as shown in FIG. 7, with the patient disposed in the lateral decubitus position. On either side of the base plate 210, patient support assemblies may be disposed, such as an anterior support assembly 300 on the anterior side, and a posterior support assembly 400 on the posterior side.

The following may be considered a method of assembling the positioner 100 in advance of surgery, and reversing the assembly method may be considered the disassembling process post-surgery.

Referring to FIGS. 1-3 and 7, the surgical patient positioner 100 is adapted to couple to the side rails 102 of an OR table 101. One or more clamps 200 may be disposed on either or both side rails 102. A corresponding drop bar 220 may be coupled to a respective clamp 200. On the posterior side, the drop bar 220 may be coupled to the base plate 210 directly via a drop bar opening 218 in the manner shown in FIG. 1. On the anterior side, a drop bar 220 may couple to an extension bracket 230 via a drop bar opening 234 disposed therein. The extension bracket 230 may be configured to couple to the base plate 210 via one or more slots 215c disposed on the underside of the plate 210, as shown in FIG. 2. This arrangement advantageously keeps the upper surface slots 215a free of obstruction, such that the anterior tower assembly 300 may be relocated amongst the plurality of slot pairs 215a without disassembling the extension bracket 230, drop bar 220, and/or clamp 200. This arrangement also advantageously moves the drop bar 220 and clamp 200 away from the surgical site, where these components are positioned further away along the side rail 102 of OR table 101; such arrangement could be for either or both anterior and/or posterior sides of the base plate 210, and is being shown disposed on the anterior side in the drawings.

The base plate 210 is preferably of sufficient length to extend laterally across the OR table 101, with anterior and posterior ends positioned above the OR table rails 102 to facilitate coupling thereto. The base plate 210 may have one or more contours 212 where it intersects with the overlying patient, the contours being characterized by one or more predetermined shapes. The contour 212 may be generally purposed to reduce the width of the base plate 210 to fit comfortably between the rib cage and pelvis of the patient, thereby avoiding pressure on skeletal tissue.

Referring to FIG. 2, on the anterior side the base plate 210 may comprise a plurality of anterior tracks 214a separated on either side by anterior track slots 215a. On the posterior side the base plate 210 may comprise a plurality of posterior tracks 214b separated on either side by posterior track slots 215b. Each anterior track 214a may comprise a plurality of anterior ratchet recesses 216a. Similarly, each anterior track 214b may comprise a plurality of posterior ratchet recesses 216b. The plurality of tracks 214a, 214b, may be of common width so that each of the anterior and posterior support assemblies 300, 400 can be precisely disposed on the base plate 210 in the caudal-cranial direction, so as to advantageously be adjusted by the surgeon according to the size and shape of a particular patient. The plurality of anterior and posterior track slots 215a, 215b, may be configured to accept suitably-shaped rails 312, 412 on anterior 300 and posterior 400 support assemblies, respectively. A plurality of anterior ratchet recesses 216a, and posterior ratchet recesses 216b may be configured to receive latches 314, 414 disposed on the anterior 300 and/or posterior 400 support assemblies, respectively.

The posterior support assembly 400 is shown in FIGS. 1-3. The posterior support assembly 400 may comprise a posterior base 402, one or more posterior towers 410, a lumbar support 420, and a posterior pad 430. The posterior support assembly 400 may be coupled to the base plate 210 by sliding one or more bottom rails 412 onto one or more tracks 214b and fixedly coupling thereto by virtue of the latch 414 rigidly coupling to a corresponding posterior ratchet recess 216b. Tower pins 418 in combination with lumbar support pin openings may be used to couple and adjust the vertical position of the lumbar support 420.

At this point in the assembly method, the patient may be positioned on the OR table 101 and aligned with the baseplate plate 210 and posterior support assembly 400. The posterior pad 430 may be optionally coupled to padding proximate the patient.

The anterior support assembly 300 is shown in FIGS. 1-7. The anterior support assembly 300 may comprise an anterior tower base 310 operably coupled to an anterior tower 320. The anterior support assembly 300 may further comprise upper 360 and lower 340 pad supports, both operably coupled to the anterior tower 320. An arm 370 may be operably coupled to the upper pad support 360. The anterior support assembly 300 may further comprise upper 350 and lower 330 pads fixedly coupled to the arm 370 and lower pad support 340, respectively, via a snap fit, or other type of coupling used in the art.

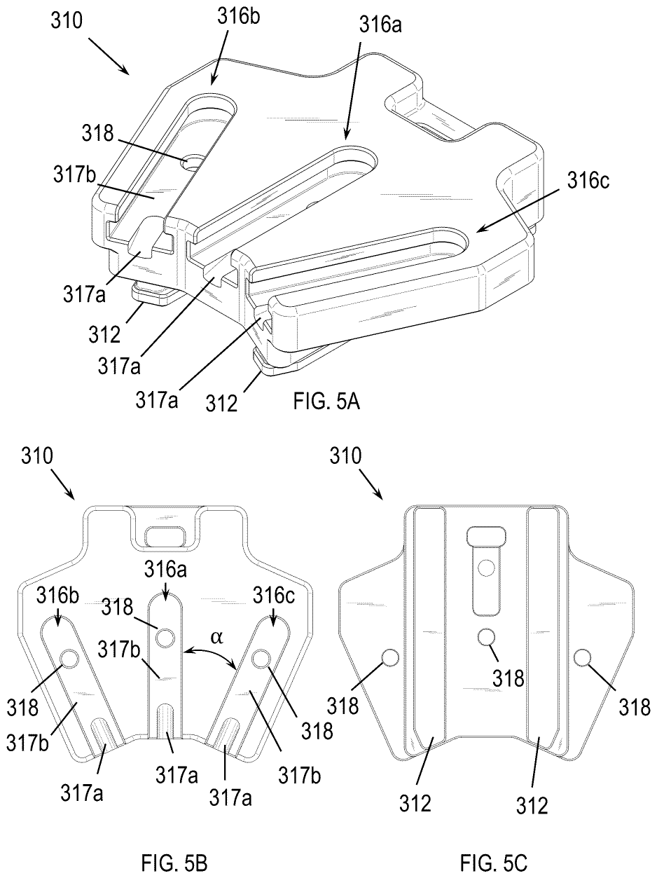

Referring to FIGS. 5A-5C, a multi-slot anterior tower base 310 is provided. The anterior tower base 310 may comprise one or more rails 312, as shown in FIG. 5C, adapted to couple to the one or more slots 215a in the base plate 210, and a plurality of slots 316a-316c adapted to receive a rail disposed on the bottom of the anterior tower 320. The slots 316a-316c, shown in FIGS. 5A and 5B, may be disposed in the top of the base plate 210 at a plurality of angles. A central slot 316a may be disposed parallel to the one or more rails 312 of the base 310; this direction may be referred to as a lateral direction, which effectively runs perpendicular to the rails of the operating room table, when the surgical patient positioner is assembled. One or more additional slots, such as slots 316b, 316c may be disposed at a common angle α, +/−, with respect to the central slot 316a as represented in FIG. 5B. In an alternative embodiment, the additional slots 316b, 316c may be disposed at dissimilar angles α, i.e. unequal. In the various embodiments contemplated herein and considered within the scope of the present invention, angle α may vary between 1 degree and 89 degrees. In this way, the anterior tower 320 may be inserted into any of the plurality of slots 316a-316c, thereby changing the angle at which the anterior tower is disposed relative to the pelvis of the patient. In various embodiments contemplated herein and considered within the scope of the present invention, the anterior tower base 310 may comprise any number of slot 316 such as, for example, 2-7 differently-angled slots. Alternatively, the anterior tower 320 and anterior base 310 may be formed as a singular piece, and therefore at a singular angle with respect to the orientation of the patient to the OR table 101. Any of the various combinations mentioned herein are considered as falling within the scope of the present invention, as may be selected and desired.

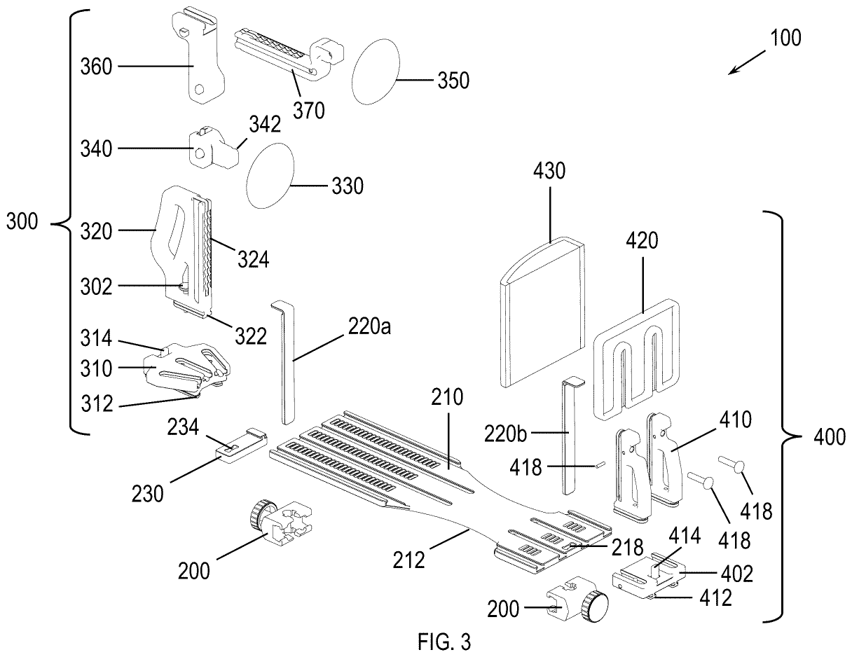

Referring to FIGS. 3-4, 6A and 6B, the anterior tower 320 may comprise a lock pin assembly 302 generally purposed to prevent slippage and achieve safe and secured locking between the tower 320 and base 310, while simultaneously providing for quick and effective assembly and/or disassembly of the positioner 100. The lock pin assembly 302 may comprise a lock pin 304, a lock pin knob 306, and a lock pin biasing element 308. Alternatively, the lock pin 304 and lock pin knob 306 may be formed of a singular construction.

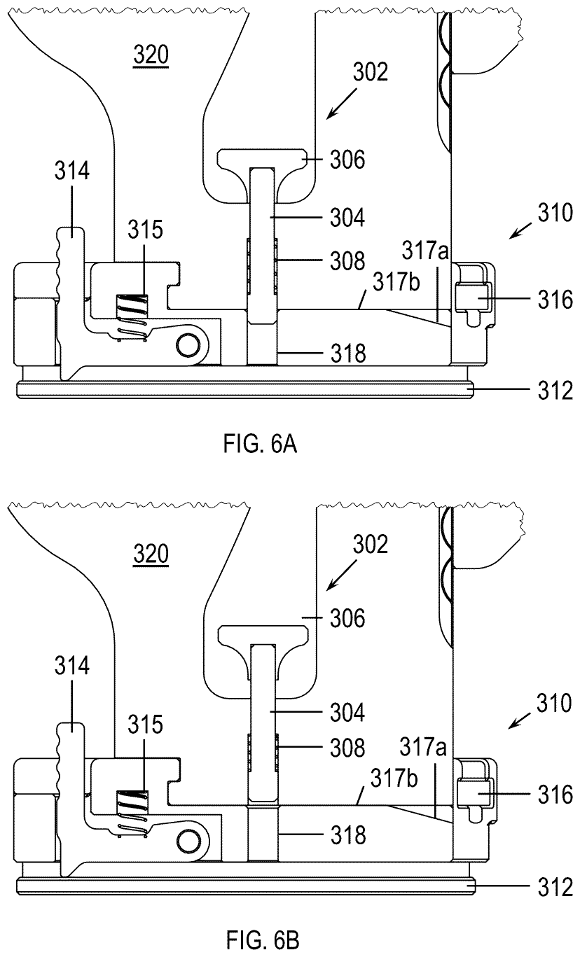

Referring to FIGS. 6A and 6B, to facilitate acceptance of the lock pin assembly 302, the anterior base 310 may comprise a lock pin ramp portion 317a, a lock pin traversing portion 317b, and one or more openings 318. The lock pin ramp portion 317a may be formed as a linear ramp portion, substantially as shown in FIG. 6A or 6B, or alternatively, may be formed as any non-linear shape, such as curved upwardly or downwardly, and other shapes adapter to allow the lock pin assembly 302 to freely traverse upon insertion of the tower rail 322 into one of the tower base slots 316a-316c 322. Furthermore, the lock pin ramp portion 317a may extend from the outer-most surface, as shown on the right-hand side of the page of FIG. 6A or 6B, and extend to about one-third the distance from that edge to the opening 318, as measured from that edge leftward toward the opening 318. Alternatively, the lock pin ramp portion 317a may extend further toward the opening 318 (at a lesser slope with respect to the horizontal). For example, the lock pin ramp portion 317a may extend all the way to the opening 318 of FIG. 6A or 6B, or may be angled at a greater slope than that which is shown. One of the defining criteria of the configuration of the lock pin ramp portion 317a is to be low enough on the right-hand side of FIG. 6A or 6B that it accepts the head of the lock pin 304 and allows the lock pin 304 to advance along the length of the body of the anterior base 310 to smoothly advance the anterior tower 320 to achieve a locked position, whereby the lock pin 304 become fixedly coupled to the opening 318.

When assembling the positioner 100, the tower rail 322 of the anterior base 310 may be inserted into one of the tower base slots 316a-316c, thereby engaging with the ramp 317 bottom of the lock pin 304 and forcing the lock pin 304 upward as the anterior tower 320 slides inwardly to mate or couple to the anterior base 310. Upon full insertion of the tower rail 322 into one of the tower base slots 316a-316c, the lock pin 304 thereby aligns with the opening 318, and the biasing element 308 moves the lock pin 304 into a fixed coupling position, thereby fixedly coupling the anterior tower 320 to the anterior base 310. In the locked position, exhibited in FIG. 6A, the biasing element 308 pushes the pin 304 into the opening 318 preventing further translation of the anterior tower 320 relative to the anterior base 310. As illustrated in FIG. 6B, to release the tower 320 from the base 310, the knob 306 is used to lift the lock pin 304 out of the opening 318 in the base slot 316 by compressing the biasing element 308. In the release position, the anterior tower 320 may be translated relative to the anterior base 310 and disassembled.

As further illustrated in FIGS. 1-4, 6A-6B and 7, the anterior tower base 310 may further comprise a latch 314, pivotably coupled to the anterior base 310 and configured to couple to the ratchet recesses 216a of the base plate 210. In an assembled configuration, such as, as the patient is being prepared for surgery as the anterior tower assembly 300 advances toward the patient the latching position advances concurrently until an appropriate demobilization of the patient is achieved with respect to the OR table 101, once the anterior support assembly 300 is appropriately coupled to the base plate 210.

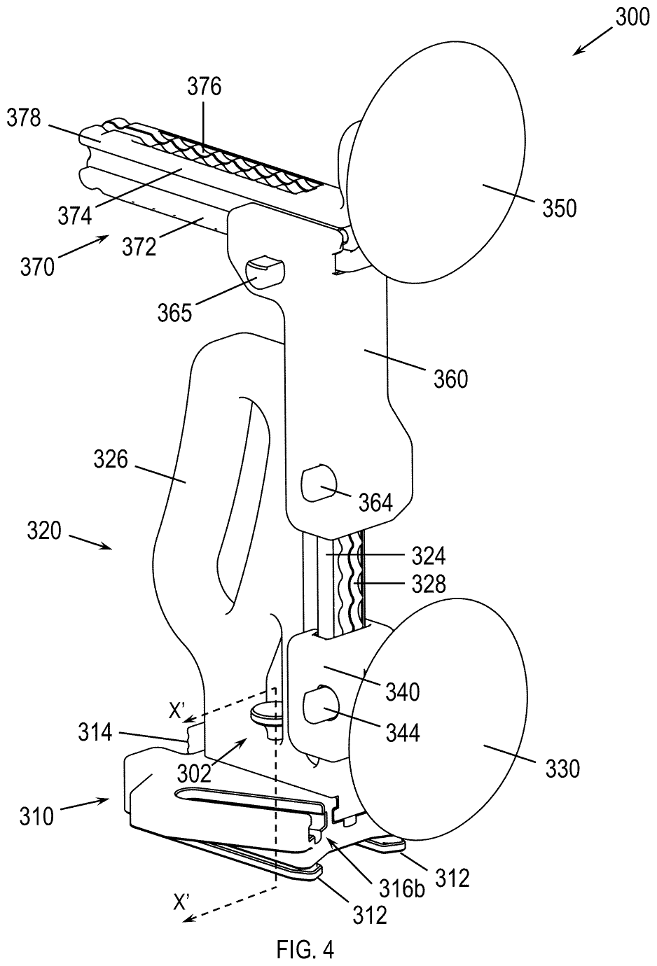

As shown, for example, in FIGS. 3-4, the anterior tower 320 may further comprise a side rail 324 configured to receive the lower pad holder 340, which may comprise a vertical slider 342 with a vertical slider slot 348 disposed therein. An anterior tower pin rack 328 may be disposed on the anterior tower 320 and serve to aid in positioning of the lower vertical slider 342 in cooperation with a lower vertical slider push pin 344. The lower pad support 340 may further comprise a lower pad adapter 346 configured to couple to the lower pad 330, typically as a snap fit or “clip-on” fit.

The anterior tower side rail 324 may also be configured to slidably couple to an upper pad support subassembly 360, which also may be coupled to the anterior tower 320 by the interaction of a vertical push pin 364 disposed on a vertical slider 362 and the anterior tower pin rack 328. The upper vertical slider 362 may be configured to slidably couple to the arm 370 with bottom 372 and top 374 rails. The arm 370 may be fixedly coupled to the upper vertical slider 362 by the interaction of a horizontal push pin 365 and arm pin racks 376, which may be disposed on bottom (not shown) and top (shown) surfaces. The arm 370 may further comprise one or more upper pad adapters 378 disposed on either or both ends and configured to receive the upper pad 350. Advantageously, the one or more upper pad adapters 378 provide for three distinct orientations of the upper pad 350 for coupling to the patient: (i) in an upward position, as illustrated in FIGS. 1 and 2, (ii) in a downward position, as illustrated in FIG. 7, and (iii) in a middle position, wherein the arm is reversed along its length (not shown).

The anterior support assembly 300 may be coupled to the base plate 210 by sliding one or more bottom rails 312 onto one or more tracks 215a and fixedly coupling thereto by virtue of the latch 314 and ratchet recesses 216a. The base plate 210 (and other components described herein) advantageously provides for multiple positioning options; for example, if the surgeon has a large patient that is difficult to reposition (once on the table), then the surgeon can modify the location and/or position of a subcomponent, e.g. anterior 300 and posterior 400 support assemblies, relative to the base plate 210 rather than having to reposition the patient.

The angled slots 316a-316c of the anterior base 310 are suitable for providing the surgeon with flexibility relating to appropriate rigid coupling of the patient with respect to the OR table 101. For example, the surgeon may desire to flex the hip joint, to check movement thereof, by positioning the leg upwardly and moving the patient's knee toward the chest then, with reference to the assembly of parts shown in FIG. 7, the use of the angled slot 316c to receive the anterior tower 320 may allow for this movement, by keeping the anterior support assembly 300 out of the way of the flexed leg. In another example, the surgeon may decide that a better hold is achieved on a particular patient when the anterior tower 320 is coupled to the angled slot 316b as shown in the assembled configuration of FIG. 7. In this orientation of the anterior tower 320, the upper and lower pads 350, 330 may be disposed at an advantageous angle relative to posterior support assembly 400; namely, relative to the contours of the lumbar support 420 and/or lumbar pad 430, to provide for improved holding.

By way of example, FIG. 1 illustrates the anterior support assembly 300 disposed on a center track 215a of the base plate 210 with the anterior tower assembly 320 occupying the center slot 316a thereby presenting the pads 330, 350 in a perpendicular orientation to the patient. Alternatively, FIG. 2 illustrates the anterior support assembly 300 disposed on a caudal-side track 215a of the base plate 210 with the anterior tower assembly 320 occupying a caudal-side slot 316b of the anterior base 310 thereby presenting the pads 330, 350 at an angle, α, to the patient. An environmental view of this orientation is illustrated in FIG. 7. The angular adjustments of the anterior tower 320 by virtue of the multi slot anterior tower base 310 may therefore provide the surgeon with improved holding characteristics of the patient with respect to the OR table 101 suitable for surgical procedures.

While certain configurations of structures have been illustrated for the purposes of presenting the basic structures of the present invention, one of ordinary skill in the art will appreciate that other variations are possible which would still fall within the scope of the appended claims. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

I claim:

1. An anterior support assembly, configured to couple to a base plate coupled to a support table for surgery of a patient disposed in the lateral decubitus position, the anterior support assembly comprising:
an anterior base configured to couple to, and slidably adjust with respect to, the base plate, the anterior base comprising a plurality of slots including:
a first slot of the plurality of slots being disposed along a first direction aligned with the anterior/posterior direction of the patient, and
a second slot of the plurality of slots being disposed in a second direction that is non-parallel to the first direction defining an angle α,
each slot of the plurality of slots having a lock pin ramp portion, a lock pin traversing portion, and a slot opening;
an anterior tower comprising a rail configured to couple to a slot of the plurality of slots, and a lock pin assembly including:
a lock pin configured to move outwardly or inwardly relative to the anterior tower, and
a biasing element configured to bias the lock pin outwardly when the lock pin is unobstructed to define a first position; and
one or more adjustable pads configured to couple to the anterior tower, the one or more adjustable pads configured to couple to the patient,
wherein, when being assembled, the rail of the anterior tower couples to a slot of the plurality of slots, such that the lock pin moves along the lock pin ramp portion, and the lock pin ramp portion automatically moves the lock pin inwardly relative to the anterior tower to a second position while the lock pin advances along the lock pin traversing portion, and then the lock pin moves back to the first position upon entering the slot opening, to fixedly couple the anterior tower to the anterior base.

2. The anterior support assembly of claim 1, wherein the base plate further comprises:
an upper surface including:
a plurality of anterior tracks configured to slidably couple to an anterior support assembly; and
a lower surface including one or more base plate slots configured to receive an extension bar, and wherein:
one or more base plate openings extend through the base plate from the upper surface to the lower surface, each of the one or more base plate openings being configured to receive a drop bar; and wherein:
the upper surface of the base plate further comprises one or more ratchet recesses,
the anterior base further comprises an anterior latch adapted to selectively inhibit movement of the anterior base along the base plate.

3. The anterior support assembly according to claim 1 further comprising a knob to allow the surgeon to manually move the lock pin from the first position to the second position.

4. The anterior support assembly according to claim 1, wherein the anterior tower further comprises an arm comprising an S-bend, the arm configured to couple one of the adjustable pads to the anterior tower, and provides for three distinct positions of that adjustable pad relative to the anterior tower by virtue of changing the arm position relative to the anterior tower.

5. An anterior support assembly, configured to couple to a support table for surgery of a patient disposed in the lateral decubitus position, the anterior support assembly comprising:
an anterior base configured to couple to, and slidably adjust with respect to, the support table, the anterior base comprising a two or more anterior base slots including:
a first anterior base slot disposed along a lateral direction, and
a second anterior base slot disposed in a second direction, offset from the lateral direction and defining an angle α,
each anterior base slot having a lock pin ramp portion, a lock pin traversing portion, and a slot opening;
an anterior tower comprising a rail configured to couple to a slot of the plurality of slots, and a lock pin assembly including:
a lock pin configured to move freely relative to the anterior tower, and
a biasing element configured to bias the lock pin outwardly when the lock pin is unobstructed to define a first position; and
one or more adjustable pads configured to couple to the anterior tower, the one or more adjustable pads configured to couple to the patient,
wherein, when being assembled, the rail of the anterior tower couples to a slot of the plurality of slots, such that the lock pin moves along the lock pin ramp portion, and the lock pin ramp portion automatically moves the lock pin inwardly relative to the anterior tower to a second position while the lock pin advances along the lock pin traversing portion, and then the lock pin moves back to the first position upon entering the slot opening, to fixedly couple the anterior tower to the anterior base.

6. The anterior support assembly according to claim 5 further comprising a knob to allow the surgeon to manually move the lock pin from the first position to the second position.

7. The anterior support assembly according to claim 5, wherein the anterior tower further comprises a handle configured to allow the surgeon to manually move the anterior tower relative to the anterior base, when assembling or disassembling the anterior tower and the anterior base.

8. A surgical patient positioner comprising:
a base plate configured to couple to a surgical support table, the base plate comprising:
an upper surface including:
a plurality of anterior tracks configured to slidably couple to an anterior support assembly, and a plurality of posterior tracks configured to slidably couple to a posterior support assembly; and
a lower surface including one or more base plate slots configured to receive an extension bar;
one or more base plate openings extending through the base plate from the upper surface to the lower surface, each of the one or more base plate openings being configured to receive a drop bar; and
at least one contoured portion adapted to fit the base plate in between the pelvis and rib cage when a patient is disposed thereon;
each drop bar comprising a drop bar head disposed at an end of a drop bar body, such that in an assembled configuration the drop bar body passes through the base plate opening and the drop bar head inhibits further movement of the drop bar therethrough;
one or more clamps adapted to couple the drop bar body to a rail of the surgical support table;
the anterior support assembly comprising:
an anterior base configured to couple to, and slidably adjust with respect to, the base plate, the anterior base comprising a plurality of anterior base rails, each anterior base rail being configured to couple to an anterior track, the anterior base further comprising two or more anterior base slots including:
a first anterior base slot disposed along a lateral direction, and
a second anterior base slot disposed in a second direction that is offset from the first direction defining an angle α,
each anterior base slot having a lock pin ramp portion, a lock pin traversing portion, and a slot opening, and
an anterior tower comprising an anterior tower rail configured to couple to one of the anterior base slots, and a lock pin assembly including:
a lock pin configured to move freely relative to the anterior tower, and
a biasing element configured to bias the lock pin outwardly when the lock pin is unobstructed to define a first position,
one or more adjustable pads configured to couple to the anterior tower, the one or more adjustable pads configured to couple to the iliac crest of a patient,
wherein, when being assembled, the anterior tower rail couples to an anterior base slot, such that the lock pin moves along the lock pin ramp portion, and the lock pin ramp portion automatically moves the lock pin inwardly relative to the anterior tower to a second position while the lock pin advances along the lock pin traversing portion, and then the lock pin moves back to the first position upon entering the slot opening, to fixedly couple the anterior tower to the anterior base,
the posterior support assembly comprising:
a posterior base configured to couple to, and slidably adjust with respect to, the base plate, the posterior base comprising at least one posterior base rail that is configured to couple to a posterior track, the posterior base further comprising at least one posterior base slot;
one or more posterior towers including a posterior tower rail configured to slidably couple to one of the posterior base slots; and
a posterior support plate configured to couple to the one or more posterior towers, the posterior support plate being suitably configured to couple to the lumbar region of the patient.

9. The surgical patient positioner of claim 8, wherein:
the upper surface of the base plate further comprises one or more ratchet recesses,
the anterior base further comprises an anterior latch adapted to selectively inhibit movement of the anterior base along the base plate, and
the posterior base further comprises a posterior latch adapted to selectively inhibit movement of the posterior base along the base plate.

10. The surgical patient positioner of claim 8, further comprising one or more extension bars configured to couple the base plate to the drop bar.

11. The surgical patient positioner of claim 8, wherein the anterior tower further comprises an arm comprising an S-bend, the arm configured to couple one of the adjustable pads to the anterior tower, and provides for three distinct positions of that adjustable pad relative to the anterior tower by virtue of changing the arm position relative to the anterior tower.
